(19) United States
(12) Patent Application Publication
(10) Pub. No.: US 2025/0223217 A1
(43) Pub. Date: Jul. 10, 2025

(54) METHODS AND APPARATUSES FOR HOMOGENIZING GLASS WORKPIECES

(71) Applicant: CORNING INCORPORATED, CORNING, NY (US)

(72) Inventors: Michael Lucien Genier, Horseheads, NY (US); Daniel Warren Hawtof, Milton, DE (US); Kenneth Edward Hrdina, Horseheads, NY (US); Douglas Hull Jennings, Corning, NY (US); Xinghua Li, Horseheads, NY (US); May Xun, Ithaca, NY (US); Chao Yu, Pittsford, NY (US)

(21) Appl. No.: 18/703,151

(22) PCT Filed: Sep. 28, 2022
(86) PCT No.: PCT/US2022/044999

§ 371 Date: Apr. 19, 2024

Related U.S. Application Data
(60) Provisional application No. 63/271,785, filed on Oct. 26, 2021.

(51) Int. Cl. C03B 32/00

(52) U.S. Cl. CPC C03B 32/00

(57) ABSTRACT

A method for homogenizing a glass workpiece, the method including heating a region of a glass workpiece by exposing the region to heat from a heat source while rotating the glass workpiece via first and second rotating assemblies and determining that the region has been heated to a mixing temperature based on a difference in rotational speeds of the first and second rotating assemblies and a distribution of the heat within the region. The method further including applying a torque to the region using the first and second rotating assemblies, wherein a temperature difference between the region and an area of the glass workpiece adjacent to and outside of the region is greater than or equal to 50° C. and less than or equal to 500° C. Additionally, the method includes heating an additional region of the glass workpiece to the mixing temperature and applying torque to the additional region.

This application claims the benefit of priority under 35 U.S.C § 120 of U.S. Provisional Application Ser. No. 63/271,785 filed on Oct. 26, 2021, the content of which is relied upon and incorporated herein by reference in its entirety.

### FIELD

The present specification generally relates to methods and apparatuses for homogenizing glass workpieces via thermomechanical mixing.

### TECHNICAL BACKGROUND

Certain applications for optical components require the glass out of which the optical components are formed to meet stringent requirements (e.g., in terms of uniformity and transparency). For example, extreme ultraviolet (EUV) lithography may require optical components to possess thermal stability (e.g., relatively low coefficients of thermal expansion) during the production of various components (e.g., circuit boards and the like). Production of high-resolution EUV circuits may be particularly sensitive to the uniformity and thermal stability of the optical components, as smaller optical components may receive more flux of EUV radiation than larger ones in fabrication processes, resulting in the optical components being subjected to highly variable thermal conditions. Certain glasses (e.g., titania doped silica glasses) may be capable of providing such thermal stability. However, existing fabrication techniques for such glasses (e.g., flame hydrolysis techniques) may result in striae or other defects in the glass, rendering optical performance unsatisfactory.

Thermomechanical mixing has been employed to homogenize workpieces for further processing into optical components. Existing thermomechanical mixing processes, however, lack mechanisms to precisely control the mixing process and/or provide distributions of heat to the glass that are suited to provide favorable mixing results.

### SUMMARY

According to a first aspect, a method for homogenizing a glass workpiece is disclosed. The method comprising heating a region of a glass workpiece by exposing the region to heat from a heat source while rotating the glass workpiece via first and second rotating assemblies attached to opposing ends of the glass workpiece and determining that the region has been heated to a mixing temperature based on one or more of a difference in rotational speeds of the first and second rotating assemblies and a distribution of the heat within the region. The method further comprising applying a torque to the region using the first and second rotating assemblies, wherein a temperature difference between the region and an area of the glass workpiece adjacent to and outside of the region is greater than or equal to 50° C. and less than or equal to 500° C. Additionally, the method comprises altering a distribution of the heat applied to the glass workpiece to heat an additional region of the glass workpiece to the mixing temperature and applying torque to the additional region.

According to another aspect, an apparatus for homogenizing a glass workpiece is disclosed. The apparatus comprising a first rotating assembly configured to hold a first end of the glass workpiece and rotate the first end of the glass workpiece about a first axis of rotation at a first rotational velocity ω1, a second rotating assembly configured to hold a second end of the glass workpiece and rotate the second end about a second axis of rotation at a second rotational velocity ω2, and a heating assembly. The heating assembly comprising a heat source configured to generate heat in a localized heating zone of the glass workpiece disposed between the first rotating assembly and the second rotating assembly and a translating assembly mechanically connected to the heat source and configured to move the heat source to alter a positioning of the localized heating zone. The apparatus further comprising a controller configured to control the first and second rotating assemblies to apply a torque to the glass workpiece as the glass workpiece is heated from an initial temperature to a mixing temperature and initiate a mixing sequence wherein ω1 differs from ω2 and a distribution of the heat within the localized heating zone after the glass workpiece reaches the mixing temperature. Furthermore, a temperature difference between the localized heating zone and an area of the glass workpiece adjacent to and outside of the localized heating zone is greater than or equal to 50° C. and less than or equal to 500° C.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a sectional view of a mixing apparatus, according to one or more embodiments described herein;

FIG. 2 depicts a flow diagram of a method of thermomechanically mixing a glass workpiece using a mixing apparatus, according to one or more embodiments described herein;

FIG. 3 depicts a flow diagram of a method of initiating a thermomechanical mixing sequence in response to determining that a region of a glass workpiece is heated to a mixing temperature based on a manipulation of the workpiece with a nominal load, according to one or more embodiments described herein;

FIG. 4 depicts a flow diagram of a method of controlling a heating assembly to provide a desired temperature distribution while thermomechanically mixing a glass workpiece, according to one or more embodiments described herein;

FIG. 5 schematically depicts a heating assembly for a mixing apparatus including a thermal radiator with a parabolic internal surface, according to one or more embodiments described herein;

FIG. 6 schematically depicts a heating assembly for a mixing apparatus including a plurality of burners arranged in parallel with a glass workpiece, according to one or more embodiments described herein;

FIG. 7 schematically depicts a ring burner configured to generate a plurality of flames that heat a glass workpiece, according to one or more embodiments described herein;

FIG. 8 schematically depicts a plurality of burners circumferentially surrounding a glass workpiece, according to one or more embodiments described herein;

FIG. 9 schematically depicts a heating assembly for a mixing apparatus including a plurality of external burners configured to heat an external surface of a thermal radiator to heat a glass workpiece, according to one or more embodiments described herein;

FIG. 10 schematically depicts a heating assembly for a mixing apparatus including a plurality of heating coils configured to heat an external surface of a thermal radiator to heat a glass workpiece, according to one or more embodiments described herein;

FIG. 11 schematically depicts a heating assembly for a mixing apparatus including an electromagnetic field generator and a susceptor configured to generate heat from an electromagnetic field that heats a glass workpiece, according to one or more embodiments described herein;

FIG. 12A schematically depicts a heating assembly for a mixing apparatus including a thermal radiator that is an elliptic cylinder sleeve through which a glass workpiece extends, according to one or more embodiments described herein;

FIG. 12B schematically depicts a heating assembly for a mixing apparatus including a thermal radiator that is an elliptic sleeve through which a glass workpiece extends at a first focus of the elliptic cylinder and comprising a thermal reflector at a second focus of the elliptic cylinder, according to one or more embodiments described herein.

### DETAILED DESCRIPTION

Reference will now be made in detail to embodiments of methods and apparatuses for homogenizing glass workpieces using thermomechanical mixing. The methods and apparatuses of the present disclosure may comprise heating assemblies designed to provide a heat distribution to a localized heating zone through which a glass workpiece extends that is adapted to generate a mixing region in the glass workpiece for elimination of various defects (e.g., bubbles, striae, layering, streaks, and the like) in the glass workpiece. In embodiments, the heat distribution generated via the heating assembly is adjustable in width to heat differently-sized sections of the glass workpiece to a mixing temperature to facilitate removal of differently-sized defects within the glass workpiece. In embodiments, the heat distribution generated via the heating assembly is configured to focus heat within the localized heating zone using a thermal radiator and a heat source to a relatively narrow region of the glass workpiece to facilitate thorough mixing of that region. In embodiments, the heating assembly comprises a plurality of heat sources and/or a thermal radiator to heat the glass workpiece to a desirable heating distribution. For example, in embodiments, the heating assembly comprises a plurality of burners that are arranged linearly along the glass workpiece. Each of the plurality of burners may be individually adjustable to generate flames of varying sizes such that the heating assembly generates a spatial distribution of heat that varies in time. Such a heating assembly may eliminate the need to move the heat source relative to the glass workpiece during mixing, thereby simplifying the mixing process. Such a heating assembly may also allow for configurability of the spatial distribution of heat such that different sections of the glass workpiece can be heated to different temperatures in a configurable time sequence to facilitate favorable mixing results. In embodiments, the heating assembly comprises a thermal radiator, a first heat source configured to heat the glass workpiece, and at least one additional heat source configured to heat the thermal radiator. Such heating of the thermal radiator using the additional heat source may facilitate heating the glass workpiece outside of a region being mixed to facilitate uniform mixing of the glass workpiece. Various heating assembly structures and methods will be described in detail herein with specific reference to the appended drawings.

The methods and apparatus of the present disclosure may also include a controller configured to implement a feedback controlling scheme based on one or more inputs received in real-time during the thermomechanical mixing process. In embodiments, the controller is configured to monitor the glass workpiece as a region of the glass workpiece is heated to determine when the region is heated to a suitable mixing temperature. For example, the controller may monitor the rotational speeds of opposing ends of the glass workpiece that are attached to first and second rotating assemblies configured to rotate the ends. The first and second rotating assemblies may be used to apply a nominal load (e.g., a load beneath a bending or breakage point of the glass workpiece at room temperature) to the glass workpiece as the glass workpiece is heated. Once the region is heated to the mixing temperature, the nominal load may result in a manipulation of the material of the glass workpiece. For example, the first and second ends of the glass workpiece may rotate at different rotational speeds as a result of the nominal load. The controller may monitor the glass workpiece during the manipulation and initiate a thermomechanical mixing sequence in response to the manipulation. In embodiments, the controller may receive inputs from one or more thermal sensors configured to sense a spatial heat distribution within the localized heating zone. The one or more thermal sensors may be used to control the heating assemblies and determine the timing of various actions (e.g., translation of the heat source relative to the glass workpiece, sequential operation of the heating assembly, rotation of the ends of the glass workpiece, etc.) in the mixing process to facilitate mixing of the material of the glass workpiece.

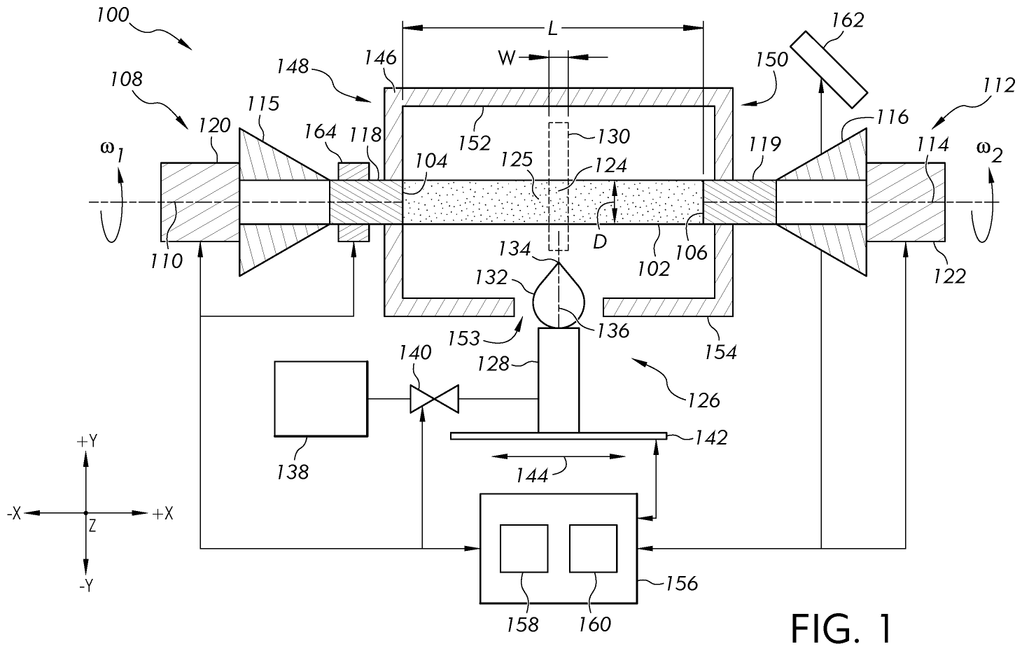

Referring now to FIG. 1, a mixing apparatus 100 is schematically depicted. The mixing apparatus 100 is configured to thermomechanically mix the material of a glass workpiece 102. The terms “thermomechanically mix” and “thermomechanically mixing,” as used herein, refer to a process in which the material of a glass workpiece is homogenized through the simultaneous application of heat energy and mechanical force to the glass workpiece. The heat energy reduces the viscosity of the material of the workpiece and the mechanical force (rotational, linear, bending or combinations thereof) promotes the homogenization of the reduced viscosity material. In embodiments, the glass workpiece 102 comprises a glass rod formed of a suitable glass composition. In embodiments, the glass composition may be, for example and without limitation, high purity fused silica or a titania-doped silica glass formed using a suitable production process (e.g., using flame hydrolysis and subsequent machining). In embodiments, the workpiece may be formed from a high silica glass, such as a glass having a silica (SiO₂) content of greater than or equal to 90 mol %, greater than or equal to 92 mol %, or even greater than or equal to 93 mol %. In embodiments, the glass workpiece 102 comprises Corning® ULE® Glass, which is a titania-silicate glass. While glass workpieces 102 having specific compositional characteristics have been referenced herein, it should be understood that the thermomechanical mixing apparatuses and methods described herein may be used to homogenize glass workpieces having other compositional characteristics according to need.

In the depicted embodiment, the glass workpiece 102 is a glass rod comprising a diameter D and a length L extending longitudinally between a first end 104 and a second end 106 of the glass workpiece 102 (e.g., in the +/−X-directions depicted in FIG. 1). Glass workpieces of different diameters D and lengths L may be used with the thermomechanical mixing apparatuses and methods described herein. For example, in embodiments, the glass workpiece 102 may have a diameter in a range from about 6 cm to about 8 cm and a length in a range from about 50 cm to about 100 cm. In embodiments, the glass workpiece 102 may have a diameter in a range from about 10 cm to about 26 cm and a length in a range from about 1 m to about 2 m. However, it should be understood that workpieces of other dimension (i.e., length and diameter) may be used with the thermomechanical mixing apparatuses and methods described herein.

Still referring to FIG. 1, the mixing apparatus 100 comprises a first rotating assembly 108 configured to hold the first end 104 of the glass workpiece 102 and rotate the first end 104 of the glass workpiece 102 about a first axis of rotation 110 at a first rotational velocity ω₁. The mixing apparatus 100 also comprises a second rotating assembly 112 configured to hold the second end 106 of the glass workpiece 102 and rotate the second end 106 about a second axis of rotation 114 at a second rotational velocity ω₂. In embodiments, the first and second rotating assemblies 108 and 112 comprise first and second spindles 115 and 116 of a lathe to facilitate rotation of the glass workpiece 102. Rotation of the glass workpiece 102 aids in promoting thermal uniformity to the heated portions of the glass workpiece 102 (such as portion 124) and also facilitates applying a torque to the glass workpiece 102 to promote mixing of the material of the glass workpiece 102 once the glass workpiece has reached a suitable temperature. For example, the first and second ends 104 and 106 of the glass workpiece 102 may be connected (e.g., welded, fused, etc.) to first and second support rods 118 and 119, respectively, which in turn are clamped to the first and second spindles 115 and 116. One or more of the first and second spindles 115 and 116 are rotatable at an adjustable speed via a suitable actuation device. In the depicted embodiment, for example, the first spindle 115 is mechanically coupled to a first actuation device 120 and the second spindle 116 is mechanically coupled to a second actuation device 122. The first and second actuation devices 120 and 122 comprise suitable drive units (e.g., electrical actuators such as electric motors, pneumatic actuators, or the like) configured to rotate the first and second ends 104 and 106 of the glass workpiece 102 at the first and second rotational velocities ω₁ and ω₂ via the first and second support rods 118 and 119, respectively.

In embodiments, the first and second axes of rotation 110 and 114 are collinear and form a common axis of rotation for the glass workpiece 102, as depicted in FIG. 1. In embodiments (not depicted), the first and second axes of rotation 110 and 114 are offset from one another in a direction extending perpendicular to the glass workpiece 102 (e.g. the Y and/or Z-directions depicted in FIG. 1). In embodiments, one or more of the first and second ends 104 and 106 may be moved during any of the mixing processes described herein to facilitate such displacement of the first and second axes of rotation 110 and 114 relative to one another. At least one of the first support rod 118 and the second support rod 119, for example, may be movable in the X or Z-directions (e.g., via attachment to the first and second spindles 115 and 116 via suitable adjustable connections) to adjust the relative position of the first and second axes of rotation 110 and 114 (e.g., between a collinear configuration and an offset configuration). For example, as described herein, the first axis of rotation 110 may be offset from the second axis of rotation 114 after a portion 124 of the glass workpiece 102 is heated to a suitable mixing temperature to apply a shear force to the portion 124 and to provide robust mixing of the glass within the portion 124 to eliminate defects therein and homogenize the material of the glass workpiece 102.

In embodiments, the first and second rotating assemblies 108 and 112 are movable relative to one another to facilitate manipulation of the material (i.e., the glass) of the glass workpiece 102 during mixing. Manipulation of the material of the glass workpiece 102 refers to the mixing and homogenization of the material that occurs once the material is heated to a suitable temperature and corresponding viscosity to allow for plastic flow of the material under an applied force. For example, in embodiments, the first and second actuation devices 120 and 122 are movable in space (e.g., using a track assembly such as a gantry, a translation stage, or other suitable movable structure) in one or more directions. For example, in embodiments, the first and second actuation devices 120 and 122 may be movable in the +/−X-directions such that the first and second ends 104 and 106 of the glass workpiece 102 may be moved towards or away from one another during mixing. Such mobility of the first and second actuation devices 120 and 122 may facilitate application of forces to the glass workpiece 102 in directions other than around the first and second axes of rotation 110 and 114 to provide more robust mixing and homogenization of the glass workpiece 102 after heating. For example, in embodiments, after the portion 124 of the glass workpiece 102 is heated to a suitable mixing temperature (for example and without limitation, to a temperature of greater than or equal to 1800° C. or even greater than or equal to 2000° C.), the first and second actuation devices 120 and 122 may be moved towards one another to compress the portion 124 and subsequently moved away from one another such that mixing occurs longitudinally along the first and second axes of rotation 110 and 114.

Referring still to FIG. 1, the mixing apparatus 100 further comprises a heating assembly 126. The heating assembly 126 comprises a heat source 128 configured to heat the portion 124 of the glass workpiece 102 to a suitable mixing temperature within a localized heating zone 130. The heat source 128 may have a variety of forms. In the embodiment depicted in FIG. 1, for example, the heat source 128 comprises a burner configured to generate a flame 132. The flame 132 comprises a tip 134 and a flame axis 136 extending through the tip 134 towards the glass workpiece 102. The localized heating zone 130 extends from the tip 134 of the flame 132 along the flame axis 136. Heat from the flame 132 is concentrated at the tip 134 of the flame 132 and heats the portion 124 of the glass workpiece 102 located in the localized heating zone 130 such that the portion 124 is heated to a first temperature that is greater than a second temperature to which another portion 125 of the glass workpiece 102 outside of the localized heating zone 130 and adjacent the tip 134 is heated.

In embodiments, during mixing, a temperature difference ΔT between the first and second temperatures of the portions 124 and 125 is greater than or equal to about 50° C. (e.g., greater than or equal to about 75° C., or greater than or equal to about 100° C., or greater than or equal to about 50° C. and less than or equal to about 500° C., or greater than or equal to about 50° C. and less than or equal to about 400° C., or greater than or equal to about 50° C. and less than or equal to about 300° C., or greater than or equal to about 50° C. and less than or equal to about 200° C., or greater than or equal to about 50° C. and less than or equal to about 100° C.). Such a temperature differential may facilitate the glass material of the portion 124 within the localized heating zone 130 to have a viscosity that is less than or equal to one-fifth of that of the portion 125. Such a viscosity differential may facilitate application of mixing forces (e.g., rotational torques via the first and second rotating assemblies 108 and 112) locally within the portion 124 to mix and homogenize the glass of the portion 124 within the localized heating zone 130 and eliminate defects therein. In embodiments, the portion 124 of the glass workpiece 102 within the localized heating zone 130 is heated to a temperature of greater than or equal to 1300° C., greater than or equal to 1400° C., greater than or equal 1500° C., greater than or equal to 1600° C., greater than or equal to 1700° C., greater than or equal to 1800° C., greater than or equal to 1900° C., or even greater than or equal to 2000° C. For example and without limitation, in embodiments, the portion 124 of the glass workpiece 102 inside the localized heating zone 130 is heated to a temperature of greater than or equal to 1800° C. while the portion 125 is heated to a temperature less than 1800° C. In embodiments, the portion 124 of the glass workpiece 102 within the localized heating zone 130 is heated to a temperature so that the portion 124 of the glass workpiece 102 within the localized heating zone 130 has a viscosity within a range from about 1×10⁴ Poise to about 1×10⁸ Poise. Without wishing to be bound be theory, it is believed that heating the portion 124 of the glass workpiece 102 to temperatures corresponding to material viscosities of from about 1×10⁴ Poise to about 1×10⁸ Poise promotes mixing of the material and allows the desired homogeneity and reduction of defects in the glass workpiece 102 to be achieved.

The localized heating zone 130 is depicted to have a width W in a direction parallel to the first and second axes of rotation 110 and 114 (e.g., in the +/−X direction of FIG. 1). In embodiments, the distribution of heat generated by the heat source 128 is adjustable to alter the width W of the localized heating zone 130. For example, the heat source 128 is depicted to be in fluid communication with a fuel source 138 (e.g., O₂ gas). A flow controller 140 (e.g., a controllable valve) is configured to control a flow rate of fuel to the heat source 128 to control a size (e.g., width) of the flame 132 to control a size of the localized heating zone 130. In embodiments, the width W is selected based on the diameter D and composition of the glass workpiece 102. In embodiments, the width W may be selected to be 0.1×D to D, 0.1×D to 0.9×D, 0.1×D to 0.8×D, 0.1×D to 0.7×D, 0.1×D to 0.6×D, or even 0.1×D to 0.5×D, depending on the viscosity of the portion 124 of the glass workpiece 102 when heated to at least a suitable mixing temperature. In some embodiments, the width W of the localized heating zone 130 is from about 5 mm to about 50 mm, or from about 5 mm to about 45 mm, or from about 5 mm to about 40 mm, or from about 5 mm to about 30 mm, or from about 5 mm to about 25 mm, or from about 10 mm to about 50 mm, or from about 10 mm to about 45 mm, or from about 10 mm to about 40 mm, or from about 10 mm to about 30 mm, or from about 10 mm to about 25 mm.

In embodiments, the width W may be dynamically adjusted during mixing to facilitate mixing different segments of the glass workpiece 102 using the same relative positioning between the heating assembly 126 and the glass workpiece 102. For example, the width W of the localized heating zone 130 may be increased, decreased, or alternately increased and decreased during a mixing operation. Such temporal fluctuations in the size of the localized heating zone 130 may alter the size of the portion 124 of the glass workpiece 102 heated to the mixing temperature such that the segment of the glass workpiece 102 where mixing occurs temporally fluctuates to facilitate removal of defects having different spatial sizes. For example, a relatively wider width W of the localized heating zone 130 may be used to remove larger scale (e.g., striae on the mm or cm scale) defects in the glass workpiece 102, while a relatively narrower width W may be used to remove smaller scale (e.g., striae on the μm or mm scale) defects in the glass workpiece 102. Alternatively or additionally, the localized heating zone 130 may be traversed over the length L of the glass workpiece 102 during the mixing operation as will be described in further detail herein.

In embodiments, the heating assembly 126 or heat source 128 is movable relative to the glass workpiece 102 to facilitate adjustment of the localized heating zone 130 to change the positioning of the portion 124 on the glass workpiece 102. In the depicted embodiments, the heat source 128 is disposed on a translating assembly 142 configured to move the heat source 128 along a translation axis 144. In embodiments, the translation axis 144 extends parallel or substantially parallel to the first and/or second axes of rotation 110 and 114. The translating assembly 142 may comprise a gantry system, a movable arm, a translation stage, or other suitable assembly for moving the heat source 128 relative to the glass workpiece 102. In embodiments, the localized heating zone 130 may be moved such that the entire length L of the glass workpiece 102 is positioned within the localized heating zone 130 for a suitable mixing period. For example, in embodiments, the localized heating zone 130 may be initially placed at the first end 104 of the glass workpiece 102 (e.g., such that the first end 104 is disposed within the localized heating zone 130 and heated to a mixing temperature). After the portion 124 within the localized heating zone 130 is mixed for a suitable mixing period, the heat source 128 may be moved in the positive X-direction such that the localized heating zone 130 overlaps with another portion of the glass workpiece 102 immediately adjacent to the first end 104 to facilitate mixing of the adjacent portion. Such a process may be repeated until the second end 106 is disposed in the localized heating zone 130 to facilitate mixing and homogenizing the entirety of the glass workpiece 102. In embodiments, the rate and amount by which the localized heating zone 130 is moved between the mixing and homogenizing of successive sections of the glass workpiece 102 is adjusted based on properties of the glass workpiece 102 (e.g., viscosity of the glass, size of the glass workpiece, etc.) and a heat distribution generated using the heating assembly 126, as described in greater detail herein.

Referring still to FIG. 1, in embodiments, the heating assembly 126 further comprises a thermal radiator 146. In embodiments, the thermal radiator 146 comprises a sleeve that circumferentially surrounds at least a portion of the glass workpiece 102 and the localized heating zone 130. The thermal radiator 146 may comprise a first open end 148 and a second open end 150 through which the glass workpiece 102 extends. As described herein, the thermal radiator 146 comprises an internal surface 152 for directing thermal radiation towards the glass workpiece 102. In embodiments, the thermal radiator 146 is constructed of a suitable glass (e.g., quartz glass) or refractory material (e.g., alumina or zirconia). The thermal radiator 146 may be heated (e.g., via conduction and radiative heat transfer) by the flame 132 and the glass workpiece 102 (e.g., when heated to the mixing temperature, the glass workpiece 102 may radiate infrared heat energy that is absorbed by the thermal radiator 146). Once heated, the thermal radiator 146 may emit infrared radiation that is absorbed (or reabsorbed) by the glass workpiece 102. In embodiments, the thermal radiator 146 may emit such infrared radiation in a Lambertian profile. As a result, the thermal radiator 146 heats the glass workpiece 102 outside of the localized heating zone 130 using the heat generated by the heat source 128. The thermal radiator 146 may reduce the temperature differential between the portion 124 of the glass workpiece 102 within the localized heating zone 130 and the portion 125 of the glass workpiece 102 outside of the localized heating zone 130.

In embodiments, portions of the glass workpiece 102 are pre-heated via the heat from the thermal radiator 146 prior to being mixed thermomechanically using the methods described herein. Such pre-heating may result in a more even radial distribution of heating within the glass workpiece 102, thereby resulting in improved mixing within central portions of the glass workpiece 102 (i.e., central portions within a thickness of the glass workpiece and distal from a surface of the glass workpiece) as compared to embodiments not including the thermal radiator 146.

The shape of the internal surface 152 of the thermal radiator 146 may at least partially determine the distribution of heat provided from the thermal radiator 146 to the glass workpiece 102. The internal surface 152 may comprise a variety of different shapes in accordance with embodiments of the present disclosure. For example, in embodiments, the thermal radiator 146 is a substantially tubular-shaped sleeve such that the internal surface 152 of the thermal radiator 146 is substantially cylindrical-shaped. Embodiments are also contemplated where the internal surface 152 is curved in the direction of the first and second axes of rotation 110 and 114 such that the radiation emitted by the internal surface 152 is preferentially provided proximate to the localized heating zone 130 to preferentially heat regions of the glass workpiece 102 at or near the time of mixing. Without wishing to be bound by theory, it is believed that such preferential heating of the glass workpiece 102 within or adjacent to the localized heating zone 130 improves the uniformity of the glass during mixing by internally heating the glass workpiece 102 prior to mixing. Various examples of different structures that may be used for the thermal radiator 146 are described in greater detail herein.

In embodiments, the thermal radiator 146 is attached to the translating assembly 142 such that the thermal radiator 146 moves relative to the glass workpiece 102 in conjunction with the heat source 128 during mixing. Such a configuration ensures that a consistent distribution of heat is successively applied to each section of the glass workpiece 102 as the localized heating zone 130 is moved across the length L of the glass workpiece 102. Embodiments are also contemplated where the thermal radiator 146 is movable independent of the heat source 128 such that the relative positioning of the heat source 128 and the thermal radiator 146 may be adjusted to alter a distribution of heat provided to the glass workpiece 102.

In the embodiment depicted in FIG. 1, the thermal radiator 146 comprises a burner access opening 153 through which the flame 132 generated by the heat source 128 extends. The burner access opening 153 beneficially facilitates positioning the tip 134 of the flame 132 in close proximity to the glass workpiece 102 to facilitate heating of the glass workpiece 102. In embodiments, the burner access opening 153 is centrally disposed within the thermal radiator 146 to facilitate a symmetrical distribution of heat provided to either side of the localized heating zone 130. In embodiments (not depicted), the burner access opening 153 is not centrally disposed within the thermal radiator 146 such that the heat radiating from the thermal radiator 146 preferentially heats glass on one side of the localized heating zone 130. For example, in an embodiment where the heating assembly 126 is moved from the first end 104 towards the second end 106 during mixing, the burner access opening 153 may be positioned more proximate to the first open end 148 than the second open end 150 such that heat from the thermal radiator 146 is preferentially provided to portions of the glass workpiece 102 yet to be mixed. Such asymmetrical heating of the glass workpiece 102 may aid in uniformly mixing the glass workpiece 102 by ensuring uniform heating of each portion of the glass workpiece 102 to a mixing temperature within the localized heating zone 130.

In embodiments, the heating assembly 126 may heat the glass workpiece 102 using heat sources other than the particular configuration depicted in FIG. 1. For example, in embodiments (not depicted), the heating assembly 126 may include at least one additional heat source configured to heat an external surface 154 of the thermal radiator 146. The heat provided by the additional heat source may be used to tailor the distribution of heat provided to the glass workpiece 102 or improve the stability of the heating of the glass workpiece 102 to provide uniform heating of the glass workpiece 102. The additional heat source may include, for example and without limitation, additional burners arranged to heat the external surface 154 of the thermal radiator 146 and/or heating coils wrapped around the external surface 154 of the thermal radiator 146. In embodiments, the additional heat source includes an electromagnetic field generator and a susceptor material positioned within (or incorporated into) the thermal radiator 146. In embodiments, any of such additional heat sources may be used instead of the heat source 128 depicted in FIG. 1. Various example embodiments of heating assemblies including such heat sources are described in greater detail herein.

The mixing apparatus 100 further comprises a controller 156. The controller 156 may include computer readable instructions stored in a memory 158 and executed by a processor 160. The instructions may be accessible by the processor 160 in accordance with an addressing scheme to control operation of the first rotating assembly 108, the second rotating assembly 112, and the heating assembly 126 in keeping with the methods described herein. The memory 158 may include one or more control modules configured to operate the first rotating assembly 108, the second rotating assembly 112, and the heating assembly 126 using a feedback control scheme utilizing signals generated by the first and second actuation devices 120 and 122 and a thermal sensor 162. In embodiments, the thermal sensor 162 comprises one or more of a thermal imaging device, a pyrometer, and a temperature sensor. While only a single thermal sensor 162 is depicted in FIG. 1, the mixing apparatus 100 may also include a plurality of thermal sensors distributed between the first and second spindles 115 and 116 and circumferentially surrounding the glass workpiece 102.

In embodiments, the thermal sensor 162 is a component of the heating assembly 126 and may move in conjunction with the heat source 128 and the thermal radiator 146 via the translating assembly 142. In embodiments, the thermal sensor 162 may be attached to the thermal radiator 146 and positioned such that a field of view of the thermal sensor 162 contains at least the localized heating zone 130 of the heat source 128. In embodiments, the thermal sensor 162 is positioned outside of the thermal radiator 146 proximate to one of the first and second open ends 148 and 150 of the thermal radiator 146 such that at least the portion 124 of the glass workpiece 102 disposed in the localized heating zone 130 is within a field of view of the thermal sensor 162. In embodiments, the thermal sensor 162 is configured to generate a thermal image representative of a spatial distribution of heat radiating from the portion 124 of the glass workpiece 102 within the localized heating zone 130 as well as portions 125 of the glass workpiece 102 outside of the localized heating zone 130.

In embodiments, signals generated by the thermal sensor 162 indicative of the heating of the glass workpiece 102 are received by the controller 156 and utilized in a feedback control scheme. For example, the controller 156 may estimate the width W of the localized heating zone 130 based on thermal radiation emitted by the glass workpiece 102 and compare the estimated width W to a desired value. Based on a difference between the estimated width W and the desired value, control signals may be provided to the flow controller 140 to change the size of the flame 132 until the width W is within a threshold of the desired value. The desired value of the width W of the localized heating zone 130 may vary over the course of the process of mixing the glass workpiece 102. As such, the feedback from the thermal sensor 162 may be used during the process of heating differently-sized segments of the glass workpiece 102 to remove defects of various different sizes.

Feedback from the thermal sensor 162 may also be used to determine the timing of aspects of the process of mixing the glass workpiece 102. For example, in embodiments, feedback from the thermal sensor 162 may be used by the controller to estimate the temperature of the portion 124 of the glass workpiece 102 within the localized heating zone 130. Once the portion 124 is heated to a desired mixing temperature (e.g., greater than or equal to 1800° C.), the controller 156 may initiate rotation of the first and second ends 104 and 106 at different rotational velocities (e.g., such that ω₁ and ω₂ differ from one another in magnitude and/or direction to create a shear zone) for a predetermined mixing period. In embodiments, ω₂ may be greater than or less than ω₁ in magnitude. In embodiments, ω₂ may be in the same direction or different directions. In embodiments, the absolute value of the difference between ω₁ and ω₂ (i.e., |ω₁−ω₂|) is in a range from 2 to 100. In embodiments, ω₂ is in a range from 2×ω₁ to 100×ω₁, from 4×ω₁ to 100×ω₁, from 5×ω₁ to 100×ω₁, from 10×ω₁ to 100×ω₁, from 15×ω₁ to 100×ω1, from 20×ω₁ to 100×ω₁, from 25×ω₁ to 100×ω₁, from 30×ω₁ to 100×ω₁, from 35×ω₁ to 100×ω₁, from 40×ω₁ to 100×ω₁, from 45×ω₁ to 100×ω₁, or even from 50×ω₁ to 100×ω₁. In embodiments, ω₂ is in a range from 2×ω₁ to 90×ω₁, from 2×ω₁ to 80×ω₁, from 2×ω₁ to 70×ω₁, from 2×ω₁ to 60×ω₁, from 2×ω₁ to 50×ω₁, from 2×ω₁ to 40×ω₁, from 2×ω₁ to 30×ω₁, from 2×ω₁ to 20×ω₁, from 20×ω₁ to 100×ω₁, or even from 2×ω₁ to 10×ω₁. For example and without limitation, in embodiments, ω₁ may be in a range from about 20 rpm to about 100 rpm. Utilizing a rotational velocity ω₁ within this range may aid in maintaining a uniform diameter of the glass workpiece 102 in the localized heating zone 130. In these embodiments, ω₂ may be, for example, up to about 1000 rpm to provide sufficient torque for mixing and homogenizing the material in the localized heating zone 130. In general, |ω₁−ω₂| increases as the viscosity of the material of the glass workpiece 102 in the portion 124 decreases. In embodiments, the rotation velocities ω₁, ω₂ may be varied during the mixing period such that the value of |ω₁−ω₂| is varied during the mixing period.

During the mixing period, feedback from the thermal sensor 162 may also be used to control the heat source 128 to maintain the width W of the localized heating zone 130 to provide consistent control of mixing. Once the mixing period is complete, the heating assembly 126 may be moved via the translating assembly 142 and a heating sequence (e.g., in which the first and second rotating assemblies 108 and 112 are rotated at comparable velocities) may be initiated to heat another portion of the glass workpiece 102.

In embodiments, feedback from the thermal sensor 162 may also be used to activate and deactivate different heat sources of the heating assembly 126 to provide a desired sequence of heating of the glass workpiece 102. The rate of translation of the heating assembly 126 relative to the glass workpiece 102 via the translating assembly 142 may also be controlled based on feedback from the thermal sensor 162. As such, each of the first and second rotating assemblies 108 and 112, the heat source 128, and the translating assembly 142 may be controlled based on feedback from the thermal sensor 162. The thermal sensor 162 provides information that may be used to precisely control the thermomechanical mixing process and to identify mixing parameters (e.g., mixing periods, temperatures, mixing torques) that may be used to remove particular defects in the glass workpiece 102 (e.g., defects on the μm to cm scale in terms of size).

In embodiments, the controller 156 also receives feedback from one or more of the first rotating assembly 108 and the second rotating assembly 112 to facilitate control of the mixing described herein. For example, the first actuation device 120 and/or the second actuation device 122 may include encoders generating positional signals indicating the rotational position of the first end 104 and the second end 106 of the glass workpiece 102 as a function of time. The controller 156 may monitor the positional signals and determine the first and second rotational velocities ω₁ and ω₂. The controller 156 may also generate drive signals that cause the first and second actuation devices 120 and 122 to rotate the first and second ends 104 and 106 at the desired speeds.

In embodiments, the controller 156 is configured to identify when the portion 124 of the glass workpiece 102 within the localized heating zone 130 is heated to a suitable mixing temperature by applying a nominal load to the glass workpiece 102 as the glass workpiece 102 is heated. In an example, the controller 156 may control the first and second actuation devices 120 and 122 to apply a rotational torque beneath the breakage point of the glass workpiece 102 based on different torques applied to the first and second ends 104 and 106 of the glass workpiece 102. That is, the control signals provided by the controller 156 to the first and second actuation devices 120 and 122 may result in the first and second rotating assemblies 108 and 112 rotating at different rotational speeds. The attachment of the first and second rotating assemblies 108 and 112 via the glass workpiece 102 thus results in a rotational torque being applied to the glass workpiece 102 when the first and second actuation devices are so controlled. When the portion 124 of the glass workpiece 102 within the localized heating zone 130 is heated to a suitable mixing temperature, however, the first and second rotating assemblies 108 and 112 may freely rotate relative to one another with reduced resistance from the glass workpiece 102. As such, the difference between the first and second rotational velocities ω₁ and ω₂ may serve as an indicator that the portion 124 of the glass workpiece 102 within the localized heating zone 130 has been heated to the mixing temperature and is ready for thermomechanical mixing. In embodiments, once the difference between the first and second rotational velocities ω₁ and ω₂ reaches a predetermined threshold, the controller 156 may initiate thermomechanical mixing by increasing the difference between the first and second rotational velocities ω₁ and ω₂ to mix the portion 124 for a predetermined mixing period.

In embodiments, the mixing apparatus 100 further comprises one or more torque limiting devices 164. The one or more torque limiting devices 164 may be used to control and/or modulate one or more of the first and second rotational velocities ω₁ and ω₂. Activation of the one or more torque limiting devices 164 may prevent the difference between the first and second rotational velocities ω₁ and ω₂ from exceeding a threshold torque during heating to prevent breakage of the glass workpiece 102. The threshold torque may vary depending on the material of the glass workpiece 102, the viscosity of the glass workpiece 102 during thermomechanical mixing, etc., and may be experimentally determined for the given conditions and material of the glass workpiece 102. In embodiments, the torque limiting devices 164 may be coupled to the controller 156 and provides signals to the controller 156 indicative of the torque on the glass workpiece 102. The controller may also monitor the rotational velocities of the glass workpiece 102 as described herein. In embodiments, when the torque on the glass workpiece 102 is constant and the rotational velocities ω₁ and ω₂ increase as determined by the controller 156, this may indicate that the glass workpiece is at risk of separation (i.e., breaking). When such conditions are detected, the controller 156 may reduce the heating applied to the glass workpiece 102 and/or reduce the difference between the rotational velocities ω₁ and ω₂ to prevent separation of the glass workpiece 102.

In embodiments, the controller 156 may apply such a nominal load to the glass workpiece 102 in directions other than rotationally. In embodiments, the nominal load may be applied by adjusting the relative position of the first and second rotating assemblies 108 and 112, thereby applying either a tensile or compressive load in a direction parallel to the axes of rotation (i.e., axes of rotation 110 and 114) or a bending load perpendicular to the axes of rotation. For example, in embodiments, the nominal load may be applied in a direction along the first and second axes of rotation 110 and 114 by applying a compressive force to the glass workpiece 102 via the first and second actuation devices 120 and 122. In embodiments, the application of a nominal load in this direction may result in the displacement of the material of the glass workpiece 102 on the order of 1 mm to several centimeters. In embodiments, the nominal load may be applied perpendicularly to the first and second axes of rotation 110 and 114 (e.g., in the +/−Y-directions depicted in FIG. 1) by applying a bending force to the glass workpiece 102 using the first and second actuation devices 120 and 122. In embodiments where the nominal load is parallel to the axes of rotation 110 and 114, the application of the nominal load may alternate between tension and compression to introduce a shearing force that enhances mixing and homogenization of the glass workpiece 102 and eliminates larger inhomogeneities in the material of the glass workpiece 102. In embodiments, the frequency at which the nominal load alternates between compression and tension may be different than the difference between the rotational velocities ω₁ and ω₂ to ensure mixing of the material during application of the nominal load.

In embodiments, the mixing apparatus 100 includes an imaging device or the like configured to monitor the shape of the glass workpiece 102. When the nominal load applied to the glass workpiece 102 results in a manipulation of the glass workpiece 102 (e.g., indicated by the difference between the first and second rotational velocities ω₁ and ω₂ and/or a change in shape of the glass workpiece 102 from the nominal load), the controller 156 may initiate thermomechanical mixing.

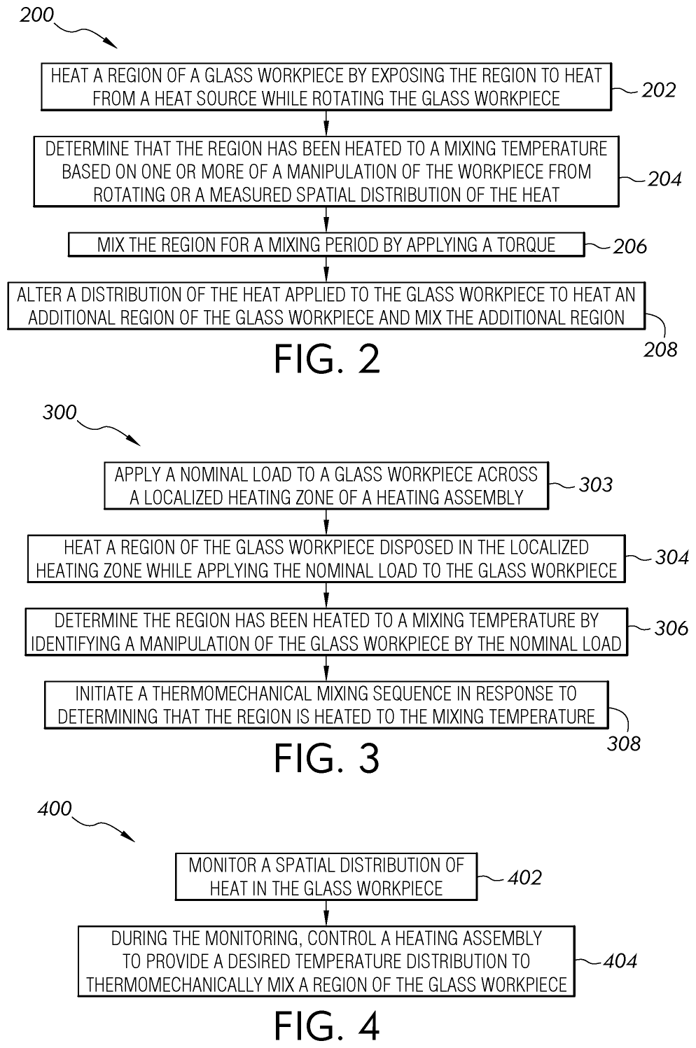

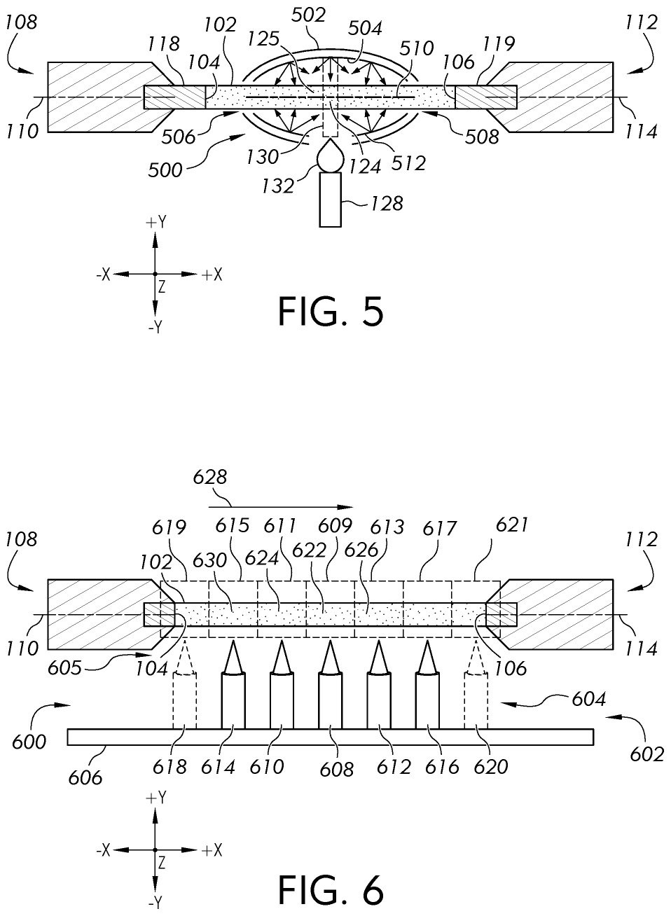

Referring now to FIG. 2, a flow a diagram of a method 200 of thermomechanically mixing a glass workpiece is depicted. The method 200 may be performed using the mixing apparatus 100 described herein with respect to FIG. 1 to homogenize the glass workpiece 102 by eliminating defects (e.g., striae, bubbles, cracks, holes, etc.) therein. Accordingly, reference will be made to various components depicted in FIG. 1 to aid in the description of the method 200. It should be understood that mixing apparatuses other than the mixing apparatus 100 depicted in FIG. 1 may be used to perform the method 200. For example, a mixing apparatus including any of the heating assemblies described herein with respect to FIGS. 5-12B may be used during the performance of the method 200.

At block 202, a region of the glass workpiece 102 is heated by exposing the region to heat from the heat source 128 while the glass workpiece 102 is rotated. For example, in embodiments, the controller 156 is configured to rotate the first end 104 of the glass workpiece 102 at the first rotational velocity ω₁ via the first rotating assembly 108 and the second end 106 of the glass workpiece 102 at the second rotational velocity ω₂ via the second rotating assembly 112. As described herein, the controller 156 may apply a nominal load to the glass workpiece 102 by providing different control signals to the first and second actuation devices 120 and 122 to facilitate detecting when the region of the glass workpiece 102 is heated to a suitable mixing temperature. While the glass workpiece 102 is rotating at an initial speed (e.g., determined by the rate at which the first and second spindles 115 and 116 are rotated by the first and second actuation devices 120 and 122 during heating), the controller 156 may provide fuel from the fuel source 138 via the flow controller 140 to generate the flame 132 and heat the portion 124 to a desired mixing temperature.

At block 204, the controller 156 determines that the region heated at block 204 is heated to a mixing temperature based on one or more of a manipulation of the glass workpiece 102 or a measured spatial distribution of heat. The measured spatial distribution of heat of the glass workpiece 102 refers to the thermal energy imparted to the glass workpiece 102 as a function of position along the length of the glass workpiece 102 as detected by the thermal sensor 162. In embodiments, the first and second actuation devices 120 and 122 may be controlled to apply a nominal load to the glass workpiece 102 during heating, such as by adjusting the relative positioning of the first and second ends 104 and 106 by manipulating the relative positioning of the first and second rotating assemblies 108 and 112. Additionally or alternatively, the first and second actuation devices 120 and 122 may be controlled to apply a nominal load to the glass workpiece 102 during heating such as by applying a rotational torque to the glass workpiece 102 via the first and second rotating assemblies 108 and 112. The controller 156 may monitor the state of the glass workpiece 102 (e.g., using an imaging device and/or by monitoring the first and second rotational velocities ω₁ and ω₂) during heating and determine a point in time when the nominal load manipulates a shape of the glass workpiece 102 (e.g., indicated by the first and second ends 104 and 106 rotating at different speeds, a bending of the glass workpiece 102, an alteration in an external shape of the glass workpiece 102), thereby indicating that the portion 124 of the glass workpiece 102 has reached a suitable temperature and corresponding viscosity to facilitate mixing and homogenization, as described herein.

At block 206, the glass workpiece 102 is mixed at the region that was heated to the mixing temperature (i.e., portion 124) via application of a torque to the glass workpiece 102. For example, once the controller 156 determines that the portion 124 is heated to the mixing temperature, the controller 156 may begin a thermomechanical mixing sequence in which the difference between the first and second rotational velocities ω₁ and ω₂ is adjusted relative to the difference between the first and second rotational velocities ω₁ and ω₂ during heating (e.g., such that the revolutions per minute (RPM) of the first and second support rods 118 and 119 differ by at least 2·ω₁). Such a difference between the first and second rotational velocities ω₁ and ω₂ may create a shear zone within the glass workpiece 102 having a size depending on the width W of the localized heating zone 130.

In embodiments, while mixing the glass workpiece 102, the controller 156 monitors the spatial distribution of heat of the glass workpiece 102 using the thermal sensor 162. In embodiments, the thermal sensor 162 may comprise a thermal imager generating a thermal image of the glass workpiece 102. The controller 156 may process the thermal image and estimate a temperature distribution of the glass workpiece 102 to monitor one or more of the width W of the localized heating zone 130 and a temperature difference ΔT between the portion 124 within the localized heating zone 130 and the portion 125 outside of the localized heating zone 130. Based on the thermal image, the controller 156 may provide control signals to the flow controller 140 to dynamically control the size of the flame 132 such that the portion 124 of the glass workpiece 102 is of a desired size and is maintained within a desired temperature range.

In embodiments, during the mixing of the region, the positioning of the heat source 128 is maintained relative to the glass workpiece 102 for a mixing period. The mixing period may be determined based on the size of the of the glass workpiece 102 (e.g., the diameter D), the composition of the glass being mixed, and the viscosity of the glass (e.g., which may at least partially depend on the mixing temperature to which the portion 124 is heated). In embodiments, while the positioning of the heat source 128 is maintained relative to the glass workpiece 102, the width W of the localized heating zone 130 may be adjusted (e.g., via control of the heat source 128) and/or the difference between the first and second rotational velocities ω₁ and ω₂ may be adjusted to alter the size of the portion 124 of the glass workpiece 102 being mixed. Such adjustments may facilitate removal of defects having different spatial sizes. In embodiments, the mixing period is determined based at least in part on the feedback from the thermal sensor 162. For example, the mixing period may be inversely proportional to a detected temperature to which the portion 124 is heated during mixing.

At block 208, the controller 156 adjusts a distribution of heat applied to the glass workpiece 102 by the heat source 128 to heat an additional region of the glass workpiece 102 and mix the additional region. For example, after a region of the glass workpiece 102 is heated to a suitable mixing temperature and mixed for a mixing period, the controller 156 may activate the translating assembly 142 to move the heating assembly 126 relative to the glass workpiece 102 by an incremental distance. In embodiments, the incremental distance is approximately equal to a minimum width W of the localized heating zone 130 used in the process of mixing a particular region of the glass workpiece. In embodiments, the incremental distance may be determined based on a detected width W of the localized heating zone 130 during heating of the previous region (e.g., based on feedback from the thermal sensor 162). In embodiments, rather than moving the heating assembly 126, the controller 156 may alter a configuration of the heat source 128 (e.g., an orientation of the heat source, a configuration of burners activated) to alter the distribution of heat applied to the glass workpiece 102 by the heat source 128.

Once the distribution of heat applied to the glass workpiece 102 is altered to heat the additional region of the glass workpiece 102, the additional region may be mixed using a mixing process similar to that described with respect to block 206. Block 208 may be repeated until an entirety of the glass workpiece 102 has been subjected to the mixing process, such that defects within the glass workpiece 102 are removed. The method 200 thus results in the homogenization of the entirety of the glass workpiece 102, rendering the glass workpiece 102 suitable for forming various optical components having stringent performance requirements. In embodiments, the mixing process may be performed in multiple iterations. For example, in embodiments, once the entirety of the glass workpiece 102 has been subjected to a first iteration of the mixing process, a second iteration of the mixing process may be performed along the length of the glass workpiece 102. Alternatively or additionally, the mixing process may be repeated on discrete segments of the glass workpiece 102 during the initial iteration of the mixing process on the entire glass workpiece 102.

Referring now to FIG. 3, a flow a diagram of a method 300 of initiating thermomechanical mixing is depicted. The method 300 may be performed using the mixing apparatus 100 described herein with respect to FIG. 1 during the method 200 described herein with respect to FIG. 2. In particular, the method 300 may be performed in place of blocks 202-204 of the method 200 in FIG. 2. Reference will be made to various components depicted in FIG. 1 to aid in the description of the method 300. It should be understood that mixing apparatuses other than the mixing apparatus 100 depicted in FIG. 1 may be used to perform the method 300. For example, a mixing apparatus including any of the heating assemblies described herein with respect to FIGS. 5-12B may be used during the performance of the method 300.

At block 302, a nominal load is applied to the glass workpiece 102 across a localized heating zone 130 of a heating assembly 126. In embodiments, the nominal load is a rotational torque applied via the controller 156 applying different mechanical loads to the first and second ends 104 and 106 of the glass workpiece 102. For example, the controller 156 may cause a rotational torque to be applied to the glass workpiece 102 across the localized heating zone 130 via the first and second rotating assemblies 108 and 112. The controller 156 may also cause forces to be applied to the first and second ends 104 and 106 in different directions by activating components that may move the first and second spindles 115 and 116. For example, each of the first and second rotating assemblies 108 and 112 may be movable in one or more directions via the first and second actuation devices 120 and 122 or other movable assemblies (not depicted) coupled thereto. By application of such forces to the first and second spindles 115 and 116, different forms of nominal loads (or other nominal forces like compression or tension) may be applied to the glass workpiece 102. The nominal load may be sufficiently low in magnitude such that the nominal load does not alter the shape of the glass workpiece 102 when the glass workpiece is at or near room temperature.

At block 304, a region of the glass workpiece is heated in the localized heating zone 130 while the nominal load is applied to the glass workpiece 102. For example, the controller 156 may heat the glass workpiece 102 using a process similar to that described herein with respect to the block 202 of the method 200 described herein with respect to FIG. 2. At block 306, the controller 156 may determine that the heated region of the glass workpiece 102 has been heated to a mixing temperature by identifying a manipulation of the glass workpiece 102 by the nominal load. The particular manipulation identified may vary depending on the nominal load or force applied to the glass workpiece at the block 302. For example, when a rotational torque is applied to the glass workpiece 102 via the first and second actuation devices 120 and 122, the controller 156 may monitor the difference between the first and second rotational velocities ω₁ and ω₂ and identify a manipulation when the difference exceeds the threshold. When compression, tension, and bending loads are applied to the glass workpiece 102 (e.g., via application of forces to the first and second spindles 115 and 116), the controller 156 may monitor the positions of the first and second ends 104 and 106 (e.g., by encoder signals associated with the first and second actuation devices 120 and 122 and/or an imaging device).

At block 308, the controller 156 initiates a thermomechanical mixing sequence in response to determining that the region heated at block 302 is heated to the mixing temperature. The thermomechanical mixing sequence may be similar to that described above with respect to block 206 of the method 200 described herein with respect to FIG. 2. As such, the nominal load described herein may be used as a way to determine that a portion of the glass workpiece 102 is ready for thermomechanical mixing based on the manipulation caused by the nominal load. The performance of the method 300 ensures that the portion 124 within the localized heating zone 130 is sufficiently heated for effective mixing to begin, while avoiding unnecessarily long heating times. The method 300 may effectively increase the efficiency of thermomechanical mixing by facilitating more precise control of process initiation than certain existing mixing techniques.

Referring now to FIG. 4, a flow a diagram of a method 400 of controlling a heat source of a mixing apparatus during thermomechanical mixing of a glass workpiece is depicted. The method 400 may be performed using the mixing apparatus 100 described herein with respect to FIG. 1 to homogenize the glass workpiece 102 by eliminating defects (e.g., striae, bubbles, cracks, holes, etc.) therein. Accordingly, reference will be made to various components depicted in FIG. 1 to aid in the description of the method 400. It should be understood that mixing apparatuses other than the mixing apparatus 100 depicted in FIG. 1 may be used to perform the method 400. For example, a mixing apparatus including any of the heating assemblies described herein with respect to FIGS. 5-12B may be used during the performance of the method 400. The method 400 may be performed during performance of the method 200 described herein with respect to FIG. 2 to facilitate control of a thermomechanical mixing process. For example, the method 400 may be employed during any of blocks 202-208 of the method 200 of FIG. 2.

At block 402, the controller 156 may monitor a spatial distribution of heat in the glass workpiece 102. As described herein, the thermal sensor 162 may be positioned such that the glass workpiece 102 is within a field of view thereof. In embodiments, the thermal sensor 162 is a heat camera or pyrometer generating a thermal image representative of a spatial distribution of temperatures to which various portions of the glass workpiece 102 are heated (e.g., during heating or mixing of the glass workpiece 102). In embodiments, the thermal sensor 162 is an array of temperature sensors disposed proximate to the glass workpiece 102 to measure a distribution of temperatures of the glass workpiece 102. The spatial distribution of heat may be monitored during heating of the glass workpiece 102 to determine when the portion 124 is heated to a suitable mixing temperature and/or when a desired temperature difference ΔT between the portion 124 of the glass workpiece 102 within the localized heating zone 130 and the portion 125 of the glass workpiece 102 outside of the localized heating zone 130 reaches a desired level.

At block 404, during the monitoring, the controller 156 may control the heating assembly 126 to provide a desired temperature distribution to thermomechanically mix a region of the glass workpiece 102. For example, the spatial distribution of heat determined based on feedback from the thermal sensor 162 may be used to control the heat source 128 such that the localized heating zone 130 comprises a desired width W during the mixing. The mixing period (e.g., the period at which the relative positioning of the heat source 128 and the glass workpiece 102 is maintained) may also be determined based on the estimated temperature of the portion 124 and the width W of the localized heating zone 130. The rate at which the heating assembly 126 is moved relative to the glass workpiece 102 (e.g., via the translating assembly 142) may also be controlled based on the monitored spatial distribution. In embodiments, the first and second rotating assemblies 108 and 112 may be controlled based on the measured spatial distribution of heat. For example, the controller 156 may initiate mixing via control of the first and second rotating assemblies 108 and 112 by determining that the portion 124 is heated to the mixing temperature based on the measured spatial distribution. The controller 156 may also stop mixing of a particular portion of the glass workpiece 102 based on feedback from the thermal sensor 162 (e.g., based on determining that the portion has been heated to the mixing temperature for a mixing period). As such, the thermal sensor 162 may facilitate more precise control of various aspects of thermomechanical mixing.

Referring now to FIG. 5, a heating assembly 500 is schematically depicted in cross-section. The heating assembly 500 may be used in replacement of the heating assembly 126 of the mixing apparatus 100 described herein with respect to FIG. 1. Accordingly, like reference numerals are used in FIG. 5 to indicate the incorporation of various components of the mixing apparatus 100. The heating assembly 500 comprises the heat source 128 described herein with respect to FIG. 1 and a thermal radiator 502. The thermal radiator 502 comprises a different shape than the thermal radiator 146 described herein with respect to FIG. 1 to provide a different distribution of heat to the glass workpiece 102. The thermal radiator 502 may provide an increased amount of heat to the localized heating zone 130 as compared to the thermal radiator 146 such that regions of the glass workpiece 102 within and adjacent to the localized heating zone 130 are preferentially heated. The heat radiated by the thermal radiator 502 may be concentrated within or near the localized heating zone 130 to reduce the time to heat the portion 124 to the mixing temperature. The concentration may also facilitate more precise control over the exact shape (e.g., the width W in FIG. 1) of the localized heating zone 130 by increasing a differential in temperature between the portion 124 of the glass workpiece 102 within the localized heating zone 130 and the portion 125 of the glass workpiece 102 disposed outside of the localized heating zone 130.

In embodiments, the thermal radiator 502 comprises a parabolic sleeve constructed of a suitable glass or refractory material (e.g., alumina, zirconia, etc.). The thermal radiator 502 may be heated by conductive and radiative heat transfer from the flame 132 generated by the heat source 128 and the heating of the glass workpiece 102. Upon heating, the thermal radiator 502 may emit infrared radiation towards the glass workpiece 102 to heat the glass workpiece 102. The thermal radiator 502 comprises a parabolic internal surface 504, a first workpiece opening 506, and a second workpiece opening 508. The glass workpiece 102 may extend through the first workpiece opening 506 and the second workpiece opening 508. In embodiments, a geometric center of the glass workpiece 102 extends through a central axis 510 of the thermal radiator 502. The parabolic internal surface 504 may be generally symmetrical over the central axis 510 to facilitate a uniform distribution of heat being provided to the glass workpiece 102 and uniform heating.

The parabolic internal surface 504 may be structured such that tangent lines 512 thereof comprise surface normals that are pointed towards the localized heating zone 130. This way, the radiation emitted by the thermal radiator 502 preferentially interacts with regions of the glass workpiece 102 within or adjacent to the localized heating zone 130. That is, with this configuration, the parabolic internal surface 504 of the thermal radiator 502 directs thermal radiation towards the localized heating zone 130. Such preferential heating facilitates faster heating of the portion 124 than the thermal radiator 146 described herein with respect to FIG. 1 and provides a greater temperature contrast between the localized heating zone 130 and areas outside of the localized heating zone 130, thereby facilitating more precise control of the boundaries of the portion 124, and better control of mixing.

Referring now to FIG. 6, a heating assembly 600 is schematically depicted in cross-section. The heating assembly 600 may be used in replacement of the heating assembly 126 of the mixing apparatus 100 described herein with respect to FIG. 1. Accordingly, like reference numerals are used in FIG. 6 to indicate the incorporation of various components of the mixing apparatus 100. The heating assembly 600 comprises a burner assembly 602 comprising a plurality of burners 604. In embodiments, the plurality of burners 604 may function similarly to the heat source 128 described herein with respect to FIG. 1. The plurality of burners 604, for example, may be in fluid communication with a fuel source (e.g., similar to the fuel source 138 described herein with respect to FIG. 1) via individually controllable valves to generate a plurality of flames 605 comprising tips extending towards the glass workpiece 102. The plurality of burners 604 may be independently controlled (e.g., via the controller 156 of FIG. 1) to provide a distribution of heat to the glass workpiece 102 that is specifically tailored to the mixing process being performed.

The plurality of burners 604 may be arranged in various different manners depending on the implementation. For example, in the depicted embodiment, the plurality of burners 604 are uniformly distributed in a linear arrangement extending parallel to the glass workpiece 102. In embodiments, the plurality of burners 604 are each disposed on a common burner support 606. In embodiments, the common burner support 606 may be movable relative to the glass workpiece 102 (e.g., via the translating assembly 142 of FIG. 1) to provide further configurability of the heat distribution provided by the plurality of burners 604 to the glass workpiece 102. In embodiments, the plurality of burners 604 are movable relative to each other to alter at least one of a spacing of the plurality of burners 604 (e.g., in the +/−X-direction) and a distance between one or more of the plurality of flames 605 and the glass workpiece 102 (e.g., via movement of the plurality of burners 604 in the +/−Y-direction) to facilitate adjustment of the heat distribution.

In the depicted embodiment, the plurality of burners 604 comprises a central burner 608 preferentially heating a central localized heating zone 609, a first inner side burner 610 preferentially heating a first side localized heating zone 611, a second side burner 612 preferentially heating a second side localized heating zone 613, a first intermediate side burner 614 preferentially heating a first intermediate localized heating zone 615, a second intermediate side burner 616 preferentially heating a second intermediate localized heating zone 617, a first outer side burner 618 preferentially heating a first outer localized heating zone 619, and a second outer side burner 620 preferentially heating a second outer localized heating zone 621. The glass workpiece 102 extends through each of the heating zones 609, 611, 613, 615, 617, 619, and 621 such that different portions of the glass workpiece 102 are preferentially heated by a different one of the plurality of burners 604. Such a configuration facilitates customizing the distribution of heat provided by the burner assembly 602 to the glass workpiece 102 according to the mixing sequence being implemented.

In embodiments, the plurality of burners 604 may be controlled to heat different portions of the glass workpiece 102 to different temperatures to control the size of the segment of the glass workpiece 102 being mixed at a particular point in time during the mixing process. For example, the central burner 608 may be controlled to heat a portion 622 of the glass workpiece 102 disposed within the central localized heating zone 609 to a first temperature T_{C}. The first inner side burner 610 may be controlled to heat a portion 624 of the glass workpiece 102 disposed within the first side localized heating zone 611 to a second temperature T_{L1}. The second side burner 612 may be controlled to heat a portion 626 of the glass workpiece 102 disposed within the second side localized heating zone 613 to a third temperature T_{R1}. In embodiments, when it is desired to mix the portion 622 of the glass workpiece 102, the first temperature T_{c} may be greater than or equal to a melting point of the glass of the glass workpiece 102, while the second and third temperatures T_{L1} and T_{R1} may be less than the melting point to define the edges of the portion of the glass workpiece 102 being mixed. In embodiments, T_{L1}=T_{R1} such that the distribution of heat provided to the glass workpiece 102 is symmetrical on either side of the tip of the flame generated by the central burner 608.

In embodiments, the first, second, and third temperatures T_{C}, T_{L1}, and T_{R1} are selected such that a quantity ΔT defined by

$$Δ T = {T}_{C} - \frac{{T}_{L 1} + {T}_{R 1}}{2} \qquad ( 1 )$$

is less than or equal to about 400° C., less than or equal to about 300° C., less than or equal to about 200° C., or less than or equal to about 100° C. Without wishing to be bound by a theory, it is believed that limiting the quantity ΔT facilitates heating of the portions of the glass workpiece 102 not being mixed to ensure thorough and uniform mixing thereof once the mixing sequence reaches such portions. In some embodiments, the quantity ΔT is greater than or equal to about 50° C. and less than or equal to about 500° C., greater than or equal to about 50° C. and less than or equal to about 400° C., greater than or equal to about 50° C. and less than or equal to about 300° C., greater than or equal to about 50° C. and less than or equal to about 200° C., or greater than or equal to about 50° C. and less than or equal to about 100° C. Controlling the plurality of burners such that the quantity ΔT is greater than 50° C. facilitates control of the dimensions of the portion 124 of the glass workpiece 102 being mixed to tune the mixing process to eliminate defects of a particular spatial size. That is, controlling the plurality of burners such that the quantity ΔT is greater than 50° C. allows for delineation between the portion 124 of the glass workpiece being mixed and the portions 125 of the glass workpiece 102 not being mixed which are adjacent to the portion 124 while also preparing the portions 125 (from a thermal perspective) for a subsequent mixing operation. The burners 614, 616, 618, and 620 may also be controlled to heat portions of the glass workpiece 102 not being mixed to provide a particular heat distribution to the glass workpiece 102.

In embodiments, the plurality of burners 604 may be controlled to alter the portion of the glass workpiece 102 that is heated to a mixing temperature to facilitate mixing. In the preceding example, the central burner 608 was described as heating the portion 622 of the glass workpiece 102 above a melting point of the glass to facilitate mixing the portion 622. However, any of the burners 608, 610, 612, 614, 616, 618, and 620 may be controlled to heat any section of the glass workpiece 102 above the melting point of the glass to alter the portion of the glass workpiece 102 being mixed. For example, at a particular point in the mixing process, the first inner side burner 610 may be controlled to heat the portion 624 above the melting point of the glass, while the central burner 608 may be controlled to heat the glass to a temperature beneath the melting point such that only the portion 624 is subjected to mixing. That is, the particular segment of the glass workpiece 102 being mixed may be changed without moving the plurality of burners 604. The burner assembly 602 may simplify the mixing process by reducing the need to move the burners.

In embodiments, the plurality of burners 604 may be controlled in accordance with a specific heating sequence to facilitate mixing an entirety of the glass workpiece 102. The plurality of burners 604 may be sequentially controlled to heat successive portions of the glass workpiece 102 to a temperature above a melting point of the glass workpiece 102 to sequentially mix different portions of the glass workpiece 102. For example, in embodiments, adjacent portions of the glass workpiece 102 are sequentially heated along a heating axis 628. The first end 104 of the glass workpiece 102 may be initially heated above the melting point via the first outer side burner 618, while the first intermediate side burner 614 may be controlled to preheat a portion 630 of the glass workpiece 102 disposed in the first intermediate localized heating zone 615 to a temperature beneath the melting point (e.g., such that a difference between the temperatures to which the first end 104 and the portion 630 are heated is greater than or equal to 50° C. and less than or equal to 500° C.). Once the first end 104 is mixed, the first intermediate side burner 614 may be controlled to heat the portion 630 to a temperature above the melting point, while the first outer side burner 618 and the first inner side burner 610 may be controlled to heat the glass workpiece 102 to temperatures beneath the melting point to achieve a desired heat distribution.

In embodiments, the plurality of burners 604 may be controlled to preferentially heat the glass workpiece 102 upstream of the portion of the glass workpiece 102 currently being mixed. For example, when the portion 622 of the glass workpiece 102 disposed in the central localized heating zone 609 is heated to a temperature above the melting point during mixing, the second side burner 612 may be controlled to heat the portion 626 to a temperature that is greater than that to which the portion 624 is heated using the first inner side burner 610. It has been found that such preferential heating in advance of mixing helps to improve the uniformity of the mixing, while heating the glass after mixing has little effect on the quality of the glass after mixing.

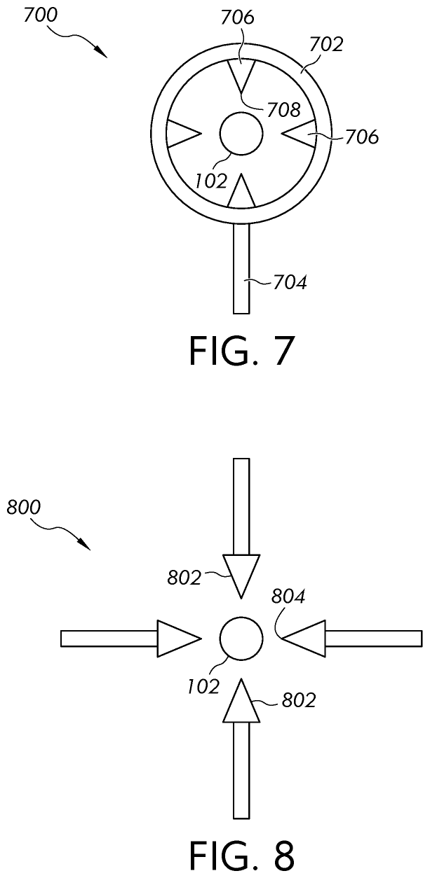

While the plurality of burners 604 in FIG. 6 is depicted to each generate a single flame to create a linear distribution of flames impinging the glass workpiece at a common circumferential (e.g., azimuthal) orientation, it should be appreciated that embodiments are contemplated where the plurality of burners 604 are arranged to surround the glass workpiece 102 and generate flames that impinge on the glass workpiece at a variety of azimuthal orientations. For example, FIG. 7 schematically depicts an axial view of a ring burner 700 that circumferentially surrounds the glass workpiece 102. The ring burner 700 comprises a circular frame 702 that is in fluid communication with a manifold 704. The manifold 704 may provide a fuel from a fuel source (e.g., from the fuel source 138 depicted in FIG. 1) to burners disposed in or extending from the circular frame 702 to provide a plurality of flames 706 that circumferentially surround the glass workpiece 102. Each of the plurality of flames 706 comprises a tip 708 extending towards the glass workpiece 102 to preferentially heat a portion of the glass workpiece 102. Embodiments are contemplated where one or more of the plurality of burners 604 of the heating assembly 600 depicted in FIG. 6 are implemented as the ring burner 700 of FIG. 7. The ring burner 700 may provide a more uniform circumferential distribution of heat to the glass workpiece 102, resulting in uniform heating and improved mixing results over using a burner with a single flame.

FIG. 8 schematically depicts an axial view of a plurality of burners 800 circumferentially surrounding the glass workpiece 102. Each of the plurality of burners 800 may operate in a manner similar to the heat source 128 described herein with respect to FIG. 1 and generate flames 802 comprising tips 804 that extend towards the glass workpiece 102 to preferentially heat a portion of the glass workpiece 102. Each of the plurality of burners 800 may be independently controlled to provide a desired circumferential distribution of heat to the glass workpiece. In embodiments, each of the plurality of burners 800 is in fluid communication with a fuel source and an amount of fuel provided thereto may be controlled. Embodiments are contemplated where each of the plurality of burners 604 of the heating assembly 600 described with respect to FIG. 6 comprises a plurality of burners comprising an arrangement similar to the plurality of burners 800 depicted in FIG. 8 to provide more uniform heating of the glass workpiece 102.

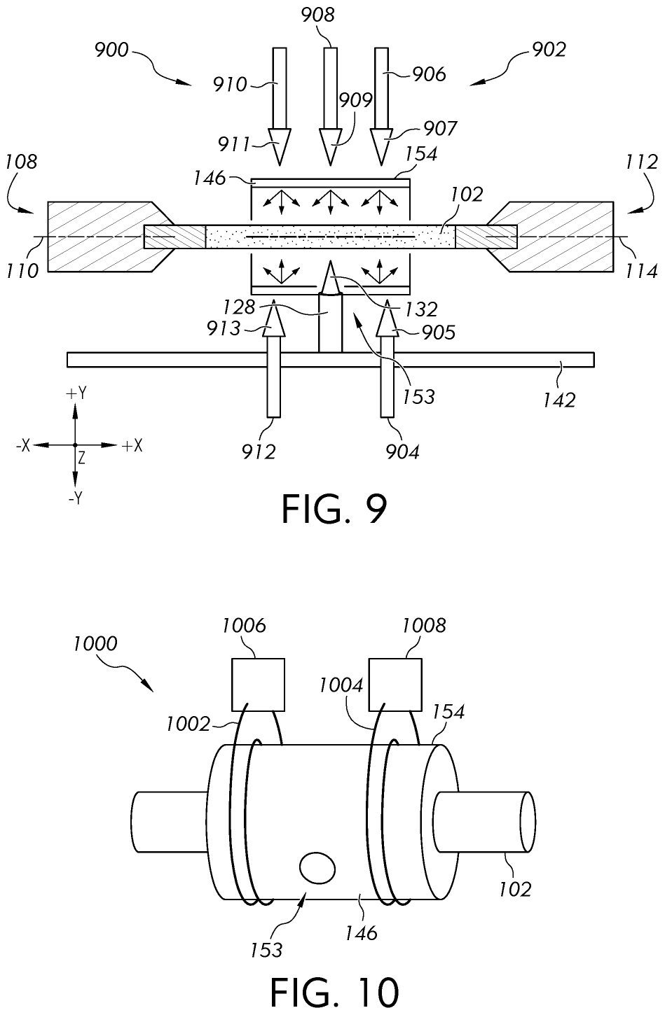

Referring now to FIG. 9, a heating assembly 900 is schematically depicted in cross-section. The heating assembly 900 may be used in replacement of the heating assembly 126 of the mixing apparatus 100 described herein with respect to FIG. 1. Accordingly, like reference numerals are used in FIG. 9 to indicate the incorporation of various components of the mixing apparatus 100. The heating assembly 900 comprises the heat source 128 and thermal radiator 146 described herein with respect to FIG. 1. As shown, the flame 132 emitted by the heat source 128 projects through the burner access opening 153 towards the glass workpiece 102 to heat the glass workpiece 102. In the heating assembly 900, the thermal radiator 146 may function as described above with respect to FIG. 1, and emit infrared radiation upon being heated (e.g., via conductive or radiative heat transfer from the heat from the heat source 128).

The heating assembly 900 further comprises a plurality of external burners 902. The plurality of external burners 902 may be disposed outside of the thermal radiator 146 and positioned to heat the external surface 154 of the thermal radiator 146. The plurality of external burners 902 may operate in a manner similar to the heat source 128 and each in fluid communication with a fuel source and individually controllable with respect to flame size. The external heat provided by the plurality of external burners 902 may stabilize the heat output by the thermal radiator 146 and render the particular distribution of heat provided by the heating assembly 900 to the glass workpiece 102 more customizable than the embodiment depicted in FIG. 1. In embodiments including the plurality of external burners 902, the thermal radiator 146 may be constructed of a refractory material such as alumina or zirconia to provide thermal stability and reliable performance.

The plurality of external burners 902 may be arranged around the thermal radiator 146 in a variety of different manners depending on the implementation. For example, in the depicted embodiment, the plurality of external burners 902 comprises a pair of first side burners 904 and 906 disposed on a first side of the heat source 128 and a pair of second side burners 910 and 912 disposed on a second side of the heat source 128. The pair of first side burners 904 and 906 and the pair of second side burners 910 and 912 emit flames 905, 907, 911, and 913 that extend towards the external surface 154 of the thermal radiator 146 to heat the thermal radiator 146 and cause the thermal radiator 146 to emit a distribution of thermal radiation that propagates at least partially towards the glass workpiece 102. In embodiments, the flames 905 and 907 emitted by the pair of first side burners 904 and 906 oppose one another at opposite ends of a diameter of the thermal radiator 146. The pair of second side burners 910 and 912 may be arranged similarly to the pair of first side burners 904 and 906. Such a configuration may ensure a substantially uniform circumferential distribution of heat being applied to the glass workpiece 102. In embodiments, the pair of first side burners 904 and 906 and the second pair of side burners 910 and 912 are components of the arrangements of burners described herein with respect to FIGS. 7-8. For example, a plurality of ring burners similar in structure to the ring burner 700 described herein with respect to FIG. 7 may be used to heat the external surface 154 in some embodiments. Additionally, a circumferential distribution of burners such as the plurality of burners 800 depicted in FIG. 8 may also be used to heat various segments of the thermal radiator 146.

The plurality of external burners 902 is also depicted to include a central external burner 908 configured to emit a flame 909 that diametrically opposes the flame 132 emitted by the heat source 128. The central external burner 908 may aid in uniformly heating the external surface 154 of the thermal radiator 146 and facilitate controlling the size of the portion of the glass workpiece 102 that is thermomechanically mixed by preferentially heating the portion of the glass workpiece 102 that is also heated using the heat source 128.

While the heating assembly 900 depicted in FIG. 9 includes the heat source 128 described herein with respect to FIG. 1, embodiments are contemplated where the heat source 128 is omitted. The heat provided by the plurality of external burners 902 may be sufficient to heat the glass workpiece 102 to the mixing temperature described herein. Individual control of the plurality of external burners 902 may enable the width of the portion of the glass workpiece 102 heated to the mixing temperature to be controlled. Such embodiments may not include the burner access opening 153 and a central pair of external burners may be provided (e.g., such that the central external burner 908 is opposed by another external burner heating the external surface 154). In embodiments, the plurality of external burners 902 are attached to the translating assembly 142 via a suitable support structure such that the plurality of external burners 902 move in conjunction with the heat source 128 to facilitate application of a consistent heat distribution to various portions of the glass workpiece 102 as they are being mixed.

While the plurality of external burners 902 are depicted to be used to heat the external surface 154 of the thermal radiator 146 described herein with respect to FIG. 1, it should be understood that the plurality of external burners 902 may be used to heat thermal radiators having a variety of different shapes and sizes. For example, the plurality of external burners 902 may be used to heat the thermal radiator 502 described herein with respect to FIG. 5 to improve the stability of the heat generated by the thermal radiator 502 during mixing. In embodiments, the particular arrangement of the plurality of external burners 902 (e.g., in terms of spacing between adjacent burners and between flames generated thereby and the glass workpiece 102) may vary depending on the thermal radiator that the plurality of external burners 902 are being used to heat.

FIG. 10 schematically depicts another heating assembly 1000 comprising heating coils 1002 and 1004 wrapped around the external surface 154 of the thermal radiator 146. The heating coil 1002 is communicably coupled to a first power supply 1006 and the heating coil 1004 is communicably coupled to a second power supply 1008. The first and second power supplies 1006 and 1008 may be individually controlled (e.g., via the controller 156 described with respect to FIG. 1) to provide a customizable distribution of heat to the glass workpiece 102 by heating the thermal radiator 146. While the depicted embodiment includes only the two heating coils 1002 and 1004 wrapped around the external surface 154, embodiments are contemplated including different numbers of coils (e.g., 2, 3, 4, 5, 6, 7, 8, 9, or an even greater number of coils). The thermal radiator 146 may be constructed of a suitable refractory material (e.g., alumina or zirconia) to provide thermal stability in view of the heating from the heating coils 1002 and 1004. In embodiments, the burner access opening 153 (e.g., for the heat source 128) may be omitted, as indirect heating of the glass workpiece 102 provided by the heating coils 1002 and 1004 may be sufficient to heat various portions of the glass workpiece 102 to suitable mixing temperatures.

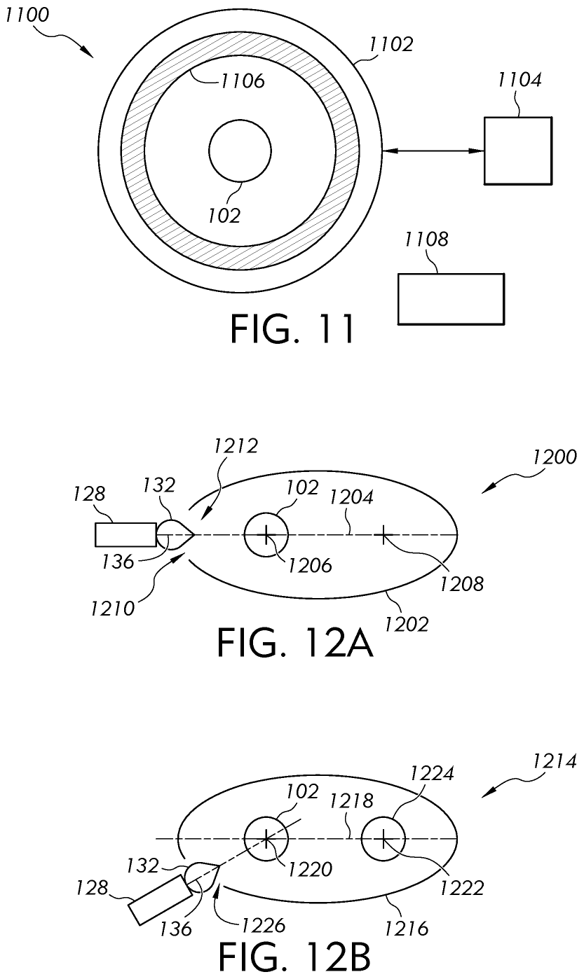

FIG. 11 schematically depicts a down-axis view of another heating assembly 1100. The heating assembly 1100 may be used in replacement of the heating assembly 126 of the mixing apparatus 100 described herein with respect to FIG. 1. The heating assembly 1100 is depicted to include electromagnetic field generator 1102 (e.g., an inductive coil) circumferentially surrounding the glass workpiece 102. The electromagnetic field generator 1102 is communicably coupled to a signal generator 1104 (e.g., a power supply) to receive an electric signal therefrom. The electrical signal (e.g., an alternating current signal comprising a frequency greater than or equal to 50 kHz and less than or equal to 500 kHz) from the signal generator 1104 may be tuned such that, upon receiving the electrical signal, the electromagnetic field generator 1102 generates an electromagnetic field. A susceptor 1106 is disposed between the electromagnetic field generator 1102 and the glass workpiece 102. The susceptor may be constructed of a suitable conductive material (e.g., graphite) or ferromagnetic material that is inductively heated by the electromagnetic field. The inductive heating of the susceptor 1106 may result in the susceptor 1106 radiating thermal energy and conductively heating gas proximate to the glass workpiece 102 to heat the glass workpiece 102.

In embodiments, the electromagnetic field generator 1102 and susceptor 1106 are integrated into the heating assembly 126 described herein with respect to FIG. 1. For example, the susceptor 1106 may be incorporated into the thermal radiator 146 (see FIG. 1) as a plurality of conductive ferromagnetic particles and/or deposited onto the internal surface 152 to provide an additional source of heat for heating the glass workpiece 102. In embodiments, the heating assembly 1100 comprises a cooling system 1108 for cooling the electromagnetic field generator 1102 and connections between the electromagnetic field generator 1102 and the signal generator 1104. The temperature to which the susceptor 1106 and/or thermal radiator 146 (see FIG. 1) are heated may render external cooling of electrical connections beneficial to maintain operability of the electromagnetic field generator 1102. The cooling system 1108 may include a fan or other suitable cooling assembly.

In embodiments, the heating assembly 1100 may not include the susceptor 1106 and the glass workpiece 102 may be heated using joule heating (also called resistive heating). For example, in embodiments, the glass workpiece 102 is pre-heated (e.g., using the heat source 128 and thermal radiator 146 described herein with respect to FIG. 1) to a temperature such that the glass is ionically conductive. Thereafter, radio frequency electromagnetic fields generated by the electromagnetic field generator 1102 may internally heat the glass workpiece 102. The resistivity of the glass workpiece 102 to the currents induced within the glass workpiece 102 by the radio frequency electromagnetic fields may result in the internal heating of the glass workpiece 102. As such, after the glass workpiece 102 is initially heated with the heat source 128 and thermal radiator 146 described herein with respect to FIG. 1, the electromagnetic fields may be used to further heat the glass workpiece 102 to a desired mixing temperature. Accordingly, embodiments are contemplated where the electromagnetic field generator 1102 is incorporated into the heating assembly 126 described herein with respect to FIG. 1 (e.g., surrounding the thermal radiator 146) to provide an additional method of heating the glass workpiece 102.

In some embodiments, heating assembly 1100 may heat glass workpiece 102 to the desired mixing temperature using microwaves. Thus, for example, electromagnetic field generator 1102 may be a gyrotron heating device that produces a microwave field. Such microwave heating provides localized heating at a precise location within the glass workpiece, so that the width and depth of the heating zone 130 may be specifically tailored. As is known in the art, microwaves are electromagnetic waves with frequencies ranging between 0.3 GHz and 300 GHz. The mechanism of microwave heating is an effect of absorption by dielectric losses. Under the microwave field, intrinsic dipole moments or induced dipole moments in dielectric materials (such as the glass workpiece 102) interact with the alternating microwave field such that the direction of the dipole moments are rearranged to align with the high-frequency microwave field. This results in energy conversion from electrical energy to heat, which heats the heating zone 130 of the glass workpiece 102.

Microwave heating using a gyrotron device causes heating at a deep penetration depth into the glass workpiece 102 (e.g., from about one mm to tens of mm deep into the glass workpiece 102) depending on the material properties and size of the workpiece. For example, a 300 GHz gyrotron microwave can reach a depth of over 40 mm in Corning® ULE® Glass when the power decays to e\hat{ }−1 of the incident power. Because gyrotron devices are able to generate high frequency internal energy sources that heat glass volumetrically, such devices provide a more effective way to heat thicker glass than traditional infrared or convective heating.

Furthermore, use of a gyrotron device to heat the glass workpiece 102 enables the ability to customize a temperature/viscosity profile from a center to an edge of the workpiece to optimize the mechanical homogenization of the glass. For example, the temperature/viscosity profile can be customized so that the center of the glass workpiece 102 within heating zone 130 is hotter than the outer edges of the glass workpiece 102 within heating zone 130 to provide more mixing at the center. Furthermore, the microwave energy can be concentrated on heating zone 130 of the glass workpiece 130 without overheating the workpiece.

As discussed above, a gyrotron device provides one example of a heating device that heats the glass workpiece internally. Another example is a laser to provide the desired mixing temperatures. Thus, in some embodiments, heating assembly 1100 may heat glass workpiece 102 to the desired mixing temperature using one or more lasers. For example, electromagnetic field generator 1102 may be a laser system that produces a laser beam. In some embodiments, the laser system may comprise a laser generation system configured to deliver a pulsed laser beam along a beam pathway. Furthermore, the laser system may comprise one or more beam shaping optics that focus the pulsed laser beam into a quasi-non-diffracting laser beam that acts along a laser beam focal line within the glass workpiece 102. Quasi-non-diffracting beams (including zero-order Bessel beams, for example) can feature an intense central spot that persists in a propagation direction substantially without apparent diffraction. This is in contrast to the focusing of standard Gaussian beams, which usually strongly diverge after a tight focus. Accordingly, single-laser quasi-non-diffracting beam pulses result in interaction zones that produce very narrow, needle-like laser heating regions within a glass workpiece. Such results in a very narrow heating zone 130 with a small width W. In some embodiments, the width W (when using the laser system disclosed herein) can be about 10 mm or less, or about 7 mm or less, or about 5 mm or less, or about 1 mm or less, or about 900 microns or less, or about 800 microns or less, or about 700 microns or less, or about 600 microns, or about 500 microns or less, or about 400 microns or less, or about 300 microns or less, or about 200 microns or less, or about 100 microns or less. In embodiments, the width W may be in a range from about 100 microns to about 10 mm, or about 100 microns to about 5 mm, or about 500 microns to about 5 mm.

The lasers of the laser system disclosed herein may be, for example, a CO laser or a CO2 laser. Exemplary near-IR or mid-IR lasers include, for example, Holmium lasers, Erbium doped solid state lasers, Thulium lasers, Holmium and Erbium doped fiber lasers, and Cr and Fe doped II-VI lasers. The lasers disclosed herein may operate at a wavelength within a range from about 2 microns to about 12 microns, or from about 2 microns to about 3 microns, or from about 5 microns to about 11 microns. In some embodiments, the laser is a CO laser that operates at a wavelength of about 5.6 microns. In other embodiments, the laser is a CO2 laser that operates at a wavelength from about 9.2 microns to about 11.2 microns. The wavelength of the laser may correlate to the thickness of the glass workpiece 102 (e.g., the diameter D). For example, a thicker glass workpiece may require a lower wavelength. It also is noted that the lasers disclosed herein provide a non-contact way to heat the glass workpiece 102 without introducing impurities.

The different heating assemblies disclosed herein may be used in conjunction with one or more other heating assemblies to heat the glass workpiece 102 to the desired mixing temperature. For example, in some embodiments, heating assemblies 1100 (including the gyrotron heating device and the laser system) may be used in conjunction with flame 132 of heating assembly 126 (or with burners 604 of heating assembly 600, or with ring burner 700, or with burners 800, or with the burners of heating assembly 900, or with heating assembly 1000). Thus, for example, flame 132 may provide external heating to the glass workpiece 102 while heating assembly 1100 provides internal heating. It is also contemplated that the heating assemblies disclosed herein (including the gyrotron heating device and the laser system) may be used with the thermal radiators disclosed herein.

FIG. 12A schematically depicts a cross-sectional view of another heating assembly 1200. The heating assembly 1200 may include the components of the heating assembly 126 described herein with respect to FIG. 1, with the exception that the thermal radiator 146 is replaced with the thermal radiator 1202. The thermal radiator 1202 is an elliptic cylinder. The depicted cross section of the thermal radiator 1202 comprises a major axis 1204, a first focus 1206, and a second focus 1208. As depicted, the glass workpiece 102 is positioned such that a geometric center thereof overlaps with the first focus 1206. As a result, thermal radiation emitted by the thermal radiator 1202 (e.g., as a result of conductive or radiative heat transfer) is preferentially emitted towards the glass workpiece 102, facilitating faster heating thereof as compared to the thermal radiator 146 depicted in FIG. 1. In embodiments, a thermal reflector or the like is positioned on the second focus 1208 to further preferentially direct thermal radiation towards the glass workpiece 102.

The thermal radiator 1202 comprises a burner access opening 1210 disposed at an end 1212 of the major axis 1204. The location of the burner access opening 1210 facilitates positioning the heat source 128 such that the flame axis 136 aligns with the major axis 1204 to facilitate a circumferentially uniform heating of the thermal radiator 1202 via the heat source 128. In particular, the heat source 128 may be used to heat the glass workpiece 102 which, in turn, radiates heat to the thermal radiator 1202. The thermal radiator 1202 then radiates heat back to the glass workpiece 102 positioned at the first focus 1206, thereby maintaining a significant amount of thermal energy within the system. FIG. 12B depicts another heating assembly 1214 comprising a thermal radiator 1216 similar in structure to the thermal radiator 1202. The thermal radiator 1216 comprises a major axis 1218, a first focus 1220, and a second focus 1222. The glass workpiece 102 is disposed such that a geometric center thereof is aligned with the first focus 1220. A thermal reflector 1224 is disposed in alignment with the second focus 1222 to facilitate directing thermal radiation towards the glass workpiece 102. In embodiments, the thermal reflector 1224 comprises a cylindrical element centered at the second focus 1222 to uniformly direct thermal radiation back towards the thermal radiator 1216 to increase the thermal energy directed towards the glass workpiece 102. In embodiments, the thermal reflector 1224 is shaped to specifically tailor the reflected radiation to particular portions of the glass workpiece 102 desired to be heated preferentially. The thermal radiator 1216 comprises a burner access opening 1226 disposed out of alignment with the major axis 1218. The heat source 128 is positioned such that the flame axis 136 extends through the first focus 1220 to preferentially heat the glass workpiece 102. The off-axis arrangement of the burner access opening 1226 may facilitate improved indirect heating of the glass workpiece 102 via the thermal radiator 1216 by optimization of the location burner access opening 1226 and use of the thermal reflector 1224 which, in turn, maximizes heat delivery from the thermal radiator 1216 and thermal reflector 1224 to the glass workpiece 102. While FIGS. 12A and 12B depict embodiments of thermal radiators that are elliptical in cross section, it should be understood that thermal radiators having different cross sectional geometries are contemplated and possible to obtain the desired focus of thermal energy on the glass workpiece 102.

In view of the foregoing description, it should be understood apparatuses and methods for homogenizing a glass workpiece using thermomechanical mixing have been shown and described. The apparatuses include one or more thermal sensors for providing feedback to control a heating assembly and rotating assemblies to ensure proper timing and intelligent control of various aspects of the thermomechanical mixing process. The thermal sensor may be used to determine when to initiate mixing, as well as to control the heating of the glass workpiece during mixing to effectuate control of the size of the segment of the glass workpiece being mixed. The apparatuses may also be configured to apply a nominal load to the glass workpiece that does not affect the shape of the glass workpiece prior to heating and monitor the shape of the glass workpiece for a manipulation in shape thereof to determine when to initiate a mixing process. Various heating assemblies have been shown to improve the heating of the glass workpiece.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for homogenizing a glass workpiece, the method comprising:
heating a region of a glass workpiece by exposing the region to heat from a heat source while rotating the glass workpiece via first and second rotating assemblies attached to opposing ends of the glass workpiece;
determining that the region has been heated to a mixing temperature based on one or more of a difference in rotational speeds of the first and second rotating assemblies and a distribution of the heat within the region;
applying a torque to the region using the first and second rotating assemblies,
wherein a temperature difference between the region and an area of the glass workpiece adjacent to and outside of the region is greater than or equal to 50° C. and less than or equal to 500° C.; and
altering a distribution of the heat applied to the glass workpiece to heat an additional region of the glass workpiece to the mixing temperature and applying torque to the additional region.

2. The method of claim 1 wherein the region has a width of about 5 mm to about 50 mm.

3. The method of claim 1, wherein the region has a width of about 10 mm to about 25 mm.

4. The method of claim 1, wherein the region has been heated to the mixing temperature when the region has a viscosity within a range from about 1×10⁴ Poise to about 1×10⁸ Poise.

5. The method of claim 1, wherein the glass workpiece comprises high purity fused silica or titania-doped silica glass.

6. The method of claim 1, wherein a thermal radiator directs the heat to the region to alter the distribution of the heat within the region of the glass workpiece, the thermal radiator circumferentially surrounding the glass workpiece.

7. The method of claim 6, wherein the thermal radiator comprises a parabolic surface that is positioned such that the heat is focused at the region of the glass workpiece.

8. The method of claim 6, wherein the thermal radiator comprises a parabolic cylindrical sleeve and the region of the glass workpiece is disposed at a first focus of the parabolic cylindrical sleeve.

9. The method of claim 8, wherein a thermal reflector is disposed at a second focus of the parabolic cylindrical sleeve, the method further comprising reflecting the heat from the thermal reflector to the region of the glass workpiece.

10. The method of claim 6, further comprising heating the thermal radiator using an additional heat source that heats an external surface of the thermal radiator.

11. The method of claim 10, wherein the additional heat source comprises a plurality of burners circumferentially distributed around the external surface.

12. The method of claim 10, wherein the additional heat source comprises a coil wrapped around the external surface.

13. The method of claim 1, wherein the heat source comprises a gyrotron heating device.

14. The method of claim 1, wherein the heat source comprises a laser system that produces a quasi-non-diffracting laser beam.

15. The method of claim 14, wherein the laser system operates within a wavelength of about 2 microns to about 3 microns.

16. The method of claim 14, wherein the laser system comprises a CO laser or a CO2 laser.

17. The method of claim 1, wherein the heat source comprises at least one burner and either a gyrotron heating device or a laser system.

18. The method of claim 1, wherein the heat source comprises a susceptor material circumferentially surrounding the glass workpiece and an electromagnetic field generator configured to generate an electromagnetic field that is received by the susceptor material and causes the susceptor material to generate thermal radiation that heats the glass workpiece.

19. The method of claim 1, wherein the first rotating assembly rotates a first end of the glass workpiece about a first axis of rotation at a first rotational velocity ω₁, the second rotating assembly rotates a second end of the glass workpiece about a second axis of rotation at a second rotational velocity ω₂, the second rotational velocity ω₂ being different from the first rotational velocity ωₛ.

20. The method of claim 19, wherein the second rotational velocity ω₂ is in a range from 2×ω₁ to 100×ω₁.

21-51. (canceled)
